(19) United States
(12) Patent Application Publication
(10) Pub. No.: US 2017/0076331 A1
(43) Pub. Date: Mar. 16, 2017

(54) METHOD AND APPARATUS FOR ADVERTISING UTILIZING DEDICATED SHORT RANGE COMMUNICATION

(71) Applicant: FORD GLOBAL TECHNOLOGIES, LLC, Dearborn, MI (US)

(72) Inventors: Oliver LEI, Windsor (CA); David Allen KOWALSKI, Toledo, OH (US); Dehua CUI, Northville, MI (US); Cynthia M. NEUBECKER, Westland, MI (US); Allen R. MURRAY, Lake Orion, MI (US); Perry Robinson MACNEILLE, Lathrup Village, MI (US); Noorulla MOHAMMED, Farmington Hills, MI (US); Brian BENNIE, Sterling Heights, MI (US)

(21) Appl. No.: 14/849,768

(22) Filed: Sep. 10, 2015

(51) Int. Cl. G06Q 30/02

(52) U.S. Cl. CPC G06Q 30/0267

(57) ABSTRACT

A system includes a processor configured to receive an indication of a trigger state indicating that a message should be broadcast over dedicated short-range communication (DSRC) from a broadcasting vehicle. The processor is also configured to select a message, in response to the trigger state, for broadcast and broadcast the selected message while the trigger state persists.

### TECHNICAL FIELD

The illustrative embodiments generally relate to a method and apparatus for advertising utilizing dedicated short range communication (DSRC).

### BACKGROUND

There are any number of on-the-spot opportunities generated by a driving environment, as changing conditions can create previously unfelt needs. For example, without limitation, a person stuck in a traffic jam around lunch time could be forced to wait a significant amount of time before eating. This is an opportunity to sell that person some food. In another non-limiting example, a person could be involved in an accident. This could be an opportunity to sell collision repair, towing, insurance (for future situations, in case their premium rises and/or their coverage is dropped) and/or legal services to that person.

Typically, in such instances, advertising a particular service would require observation of the condition, having appropriate material (business cards, food, flyers, etc.) on hand, and some form of material delivery. One could approach the vehicle on foot, but if the traffic jam is large, this could take hours, and in the case of an accident, personally approaching an agitated driver just involved in an accident could be annoying, dangerous and even prohibited if the police are present.

A V2V advertising solution has been previously proposed, which includes a system and method for providing geo-service advertising messages using a wireless vehicle-to-infrastructure (V2X) communications network. Messages are transmitted from a business that identify the type of business, the name of the business and the location of the business, which are received by vehicles traveling within a certain distance of the business. The messages can be rebroadcast by the vehicles receiving the messages from the business to other vehicles either in a multi-hop information routing manner or in a delay-tolerant network information dissemination fashion so that the messages are sent to a wider area, but within a predetermined geographic area and within a predetermined time. If a particular user of the system wishes to learn about a particular business or type of business, he can activate the system so that the messages being sent between the vehicles and from the businesses can be displayed to the user for his use.

In another example, methods, systems, software, computer-readable media, and the like relate to providing and receiving relevant data from one or more entities. Data is received by a wireless user device directly from a wireless transmitter. The data may be provided to a stationary or moving user. A consumer in a vehicle, for instance, may have a smartphone, mobile phone, tablet PC, navigation system, or other similar mobile device, and can use such device to interact with a geographically proximate advertising module having a wireless transmitter. The wireless transmitter may also be stationary or moving, and can be incorporated into structures such as a vehicle, a billboard, a building, a road sign, a traffic light, or the like.

### SUMMARY

In a first illustrative example, a system includes a processor configured to receive an indication of a trigger state indicating that a message should be broadcast over dedicated short-range communication (DSRC) from a broadcasting vehicle. The processor is also configured to select a message, in response to the trigger state, for broadcast and broadcast the selected message while the trigger state persists.

In a second illustrative example, a system includes a processor configured to receive a dedicated short-range communication (DSRC) message from a local vehicle. The processor is also configured to evaluate the relevance of the message to a vehicle occupant and present the message to the vehicle occupant upon a determination that the message is relevant.

In a third illustrative embodiment, a system includes a processor configured to establish communication with a local vehicle over a dedicated short-range communication (DSRC) channel based on receipt of a message from the local vehicle over the DSRC channel and a user-initiated communication request. The processor is also configured to communicate with the local vehicle over the DSRC channel to facilitate a business transaction and establish a long-range persistent communication with the local vehicle upon a determination that the local vehicle is reaching the range limits of the DSRC channel and that further communication is desired.

### BRIEF DESCRIPTION OF THE DRAWINGS

FIG. 1 shows an illustrative vehicle computing system;

FIG. 2A shows an illustrative process for broadcasting an advertisement;

FIG. 2B shows an illustrative process for receiving and handling an advertisement;

FIG. 3 shows an illustrative process for advertisement configuration;

FIG. 4 shows an illustrative process for advertisement selection, generation and transmission; and

FIG. 5 shows another illustrative process for advertisement handling.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

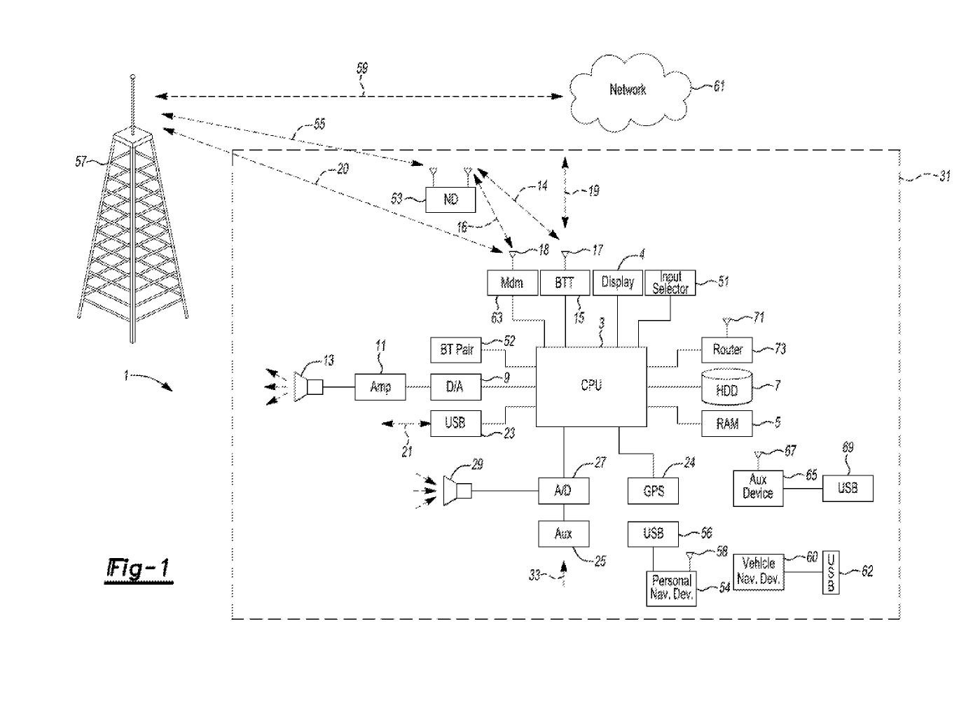

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

As previously noted, changing traffic conditions generate countless opportunities for on-the-spot advertising. Because a driver's/occupant's needs may change with traffic changes, or other variables, there is an opportunity to deliver on-demand goods and services to these people. Unfortunately, access to the information about immediate needs is difficult to correlate with a good or service provider, due to the fact that the good or service provider is typically in a fixed location and the vehicle occupant is typically moving. Also, the vehicle occupant may have other things on their mind, and only in the presence of direct notification of an opportunity to fulfill a need may they focus on the present need.

As such, a system incorporating dedicated short range communication (DSRC) is envisioned whereby passing vehicles having need-fulfilling capability, or relating to a need-fulfilling business, can receive or guess information about a present need, communicate with vehicles in an unobtrusive manner to gauge actual need, and communicate with occupants if a need is identified which the passing vehicle can assist in fulfilling. Dedicated short-range communications (e.g., IEEE 1609, IEEE 802.11p, SAE J2735) are one-way or two-way short-range to medium-range wireless communication channels that may be specifically designed for automotive use and correspond to a set of protocols and standards. All wireless messages are broadcast to all receivers in range.

DSRC has a dual-stack. One stack is TCP/UDP Transport Layer over IPv6 (Internet protocol version 6), that is comparable to WiFi and Cellphone connections and the other is DSRC WAVE Short Message Protocol (WSMP). Receivers are responsible for filtering the messages as needed. TCP messaging is the most complex and robust, supporting one-to-one virtual circuits. UDP is less complex, faster, but lacks the delivery guarantees of TCP. WSMP is very fast so that moving vehicles can communicate through short time windows, but is less robust. In one illustrative example case WSMP would be useful for advertisements because they can be re-broadcast and losing a message isn't critical.

Using these channels, automobiles can communicate with each other to send, receive and subsequently filter the proposed advertising, which can facilitate an on-the-spot business relationship with respect to an immediate (or previously present) driver need or want. Non-limiting examples of the use of the illustrative embodiments include a food truck sending a menu to vehicles in a traffic jam and a tow-truck sending tow-offerings to vehicles involved in an accident. Coupons, business information and other data can also be sent in this manner, to facilitate a business relationship.

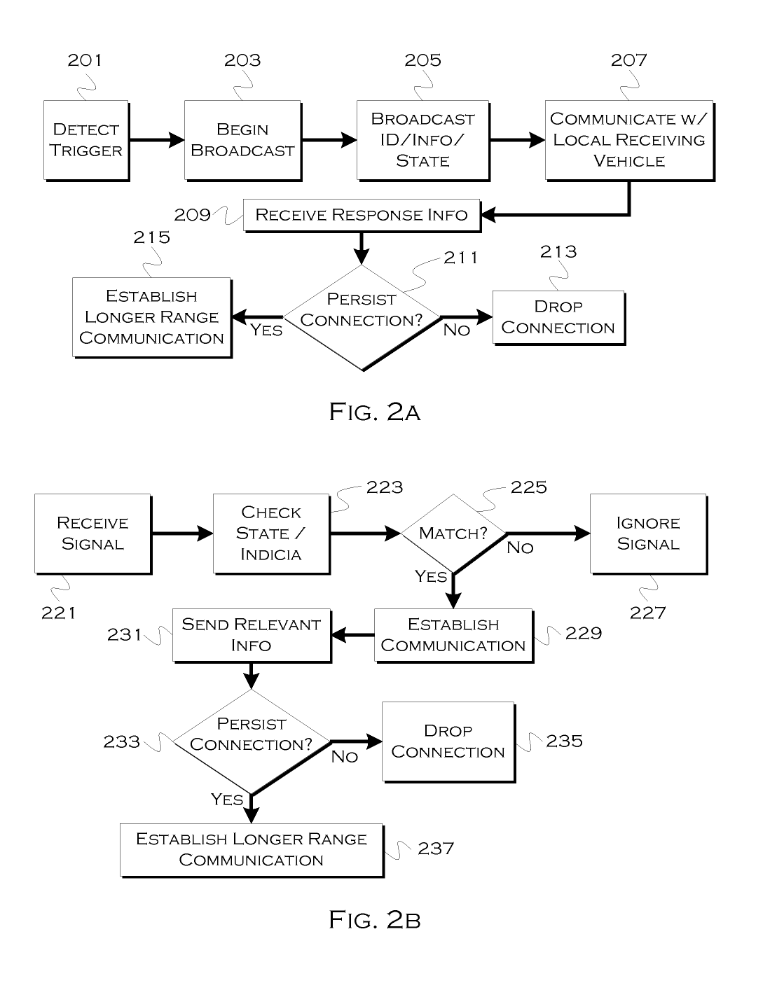

FIG. 2A shows an illustrative process for broadcasting an advertisement. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative example shown in FIG. 2A, the process first detects a trigger for generating/sending an advertisement 201. In this example, the process is running on an advertiser-side vehicle, although in an alternative embodiment such triggers could be used to send a request as will be described below. In some examples, the advertisement may be persistently broadcast as a vehicle travels, but in other examples a trigger may initiate communication.

Triggers can be almost anything, from an occupant initiated trigger (i.e., the driver sees an opportunity related to their particular business) to a traffic-report (relating, for example, to any traffic in a predefined proximity) to a request from one or more local vehicles. These are just some of the non-limiting examples that can encompass triggers. Triggers can be context driven using informational filters.

Once the advertisement is triggered, the process begins to broadcast the advertisement over a DSRC channel, for receipt by local vehicles also provided with access to the DSRC channel 203. In this example, the broadcast advertisement includes some form of identification (ID), information relating to the service or goods, and a state value that is usable by the receiving vehicle to filter the advertisement 205. In other examples, the information included can be tailored as appropriate for the system implemented and the situation (e.g., could include coupons, directions to a business, contact information, etc.).

Once one or more local vehicles has “received” the communication and not dropped/filtered the communication as irrelevant to occupants, the process can communicate with the vehicle to further define the business relationship 207. This could include a receipt of request for services, a menu selection, a coupon request, directions request, contact information request, etc 209. Since the advertising vehicle may be moving, and may not be able to maintain the DSRC connection indefinitely (if the range limit of the DSRC channel is reached, for example), if the connection with the receiving vehicle needs to persist 211, accommodation can be made for longer range communication 215 (via the cloud, for example). Otherwise, if the relevant information has been transferred and the connection is no longer needed, the process may drop the communication 213.

WSMP messages aren't connection oriented. They are simply sent to all vehicles in range with a Provider Service Identifier (PSID), which is a number that determines to which application the message should be passed. A packet could be passed through a message discovery and delivery service (MDDS) such as an “intent” in the Google Android operating system. Services running in the environment can receive the contents of the message via the intents then can act on the information or not. For example, first a trigger will cause a message to be sent at a particular power level. When it is received by all the vehicles in range, these vehicles' computers convert it to a MDDS message that is broadcast to all apps that have subscribed to that message. Applications running on the vehicles then decide how it should be processed, for example, using an informational filter as described above.

In a similar instance, instead of a trigger for broadcasting information, a user may select some vehicle feature defining one or more present needs. In other examples, some needs may be dynamically identified (e.g., a traffic condition, indicated by stop and go driving and/or traffic reports, combined with a lunch time hour may automatically initiate a “hungry” state). Based on automatic or user selection, the vehicle can broadcast a request over DSRC to any local vehicles that may be passing by which could help fulfill the identified need. Thus, in such an example, the request as opposed to the advertisement is initially triggered, but then the request may serve as a trigger for the advertisement (or, alternatively, may result in receipt of the advertisement from a broadcasting vehicle).

FIG. 2B shows an illustrative process for receiving and handling an advertisement. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a vehicle receives a DSRC communication 221 from another vehicle. In this example, some state or indicia is included with the communication that the receiving vehicle can use to help determine the relevance of the communication 223. A fairly simple non-limiting example includes some pre-defined finite list of states or indicia, wherein a state or indicia included with the advertisement (e.g., food, hungry, lunch, meal, etc) is compared to a vehicle receipt state identified by a user or automatically set based on conditions. That is, a receiving user could indicate that they are hungry and/or the vehicle could assume hunger based on time of day, traffic conditions, previously observed user behavior, etc. Similar models could be used in the case of an accident (where the vehicle or user could indicate the “accident” state) or other needs of a particular vehicle occupant.

In some examples, the “receiving” vehicle may only switch into receiving mode if the vehicle has explicitly requested some form of DSRC message. That is, all DSRC (or at least all advertising type DSRC) messages may be ignored unless the occupant has sent a request out for such messages, which can cause the vehicle computer to go into a message-receiving mode.

DSRC defines the WAVE service advertisement (WSA) messages used to announce the services available. For example, a vehicle can announce a service for receiving restaurant advertisements on a prescribed PSID, along with its location and other information. When a WSMP message is transmitted with the PSID all the vehicles with apps that accept that service will receive the message. Otherwise the message may be ignored.

If there is no match between the advertisement indicia and the vehicle state-identifier 225, the process will simply ignore the communication 227 in this example. Alternatively, the communication could always be presented, but this may result in an over-inundation if a number of local advertising vehicles adopted this model, and so some form of filtration may assist in reducing user annoyance.

Once there is a match between the advertisement and a user-requested/vehicle-requested indicia 225, the process can establish communication between the receiving vehicle and the advertising vehicle 229. Any additional relevant information not present in the initial advertisement can be exchanged 231. As with the broadcast example in FIG. 2A, the process can also determine if longer-range communication is needed to complete a transaction 233. If not needed, the connection can be dropped 235, or, alternatively, if the communication is needed and one of the vehicles moves out of range, the process can switch to a more persistent longer-range form of communication 237.

For example, one vehicle can send a message with a prescribed PSID field to any vehicles listening for messages with that PSID field. To establish one-to-one communications between vehicles the vehicles use a prescribed PSID to set up unique PSID pairs that the vehicles can use to send messages. It may also be desirable to encrypt the messages.

Normally this isn't needed for these types of communication. For example, a seller with food sends a WSMP message with the prescribed PSID for restaurants. Vehicles interested in purchasing food set their DSRC receivers to receive messages from food sellers and pass them to one or more specific apps which offer the necessary services in their manifests.

FIG. 3 shows an illustrative process for advertisement configuration. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, an advertiser (or requesting user) can configure an advertisement or service-request. The configuration process is initiated 301, which can include initiation automatically by a vehicle for a vehicle-automatic state setting. A variable (state/indicia) selection is made for the appropriate categories 303. In this example, some limited form of state/indicia vocabulary is considered as the basis for selection, whereby correspondence to a receiving vehicle can be assured (i.e., both parties choose from the same list), but in other examples, some form of predictive algorithm can be used to find matches (i.e., user indicates “hunger” advertiser indicates “food” algorithm matches “food” and “hunger”). It is also important to note that such filtration isn't necessary, and the advertisement or request could simply be sent to all surrounding vehicles with the appropriate information included (i.e., some form of content) and the receiving vehicles or users could decide what, if any, action to take.

For example, for food the advertiser may send a menu with a description of the product and its cost in message(s) containing the appropriate PSID. If conditions change, such as one item isn't selling well, the prices (or coupons, etc.) can be changed in subsequent messages.

Here, the selected indicia/state variables are included with the content of the advertisement, usable for filtering purposes at least 305. In other examples, the variables may be used for sorting purposes, so a user's vehicle could receive all advertisements and sort them for user access upon demand, for example. The configuration is saved for later use in broadcast 307 or for use in an immediate broadcast. Also, any trigger conditions could be set at this time as the basis for initiating a broadcast.

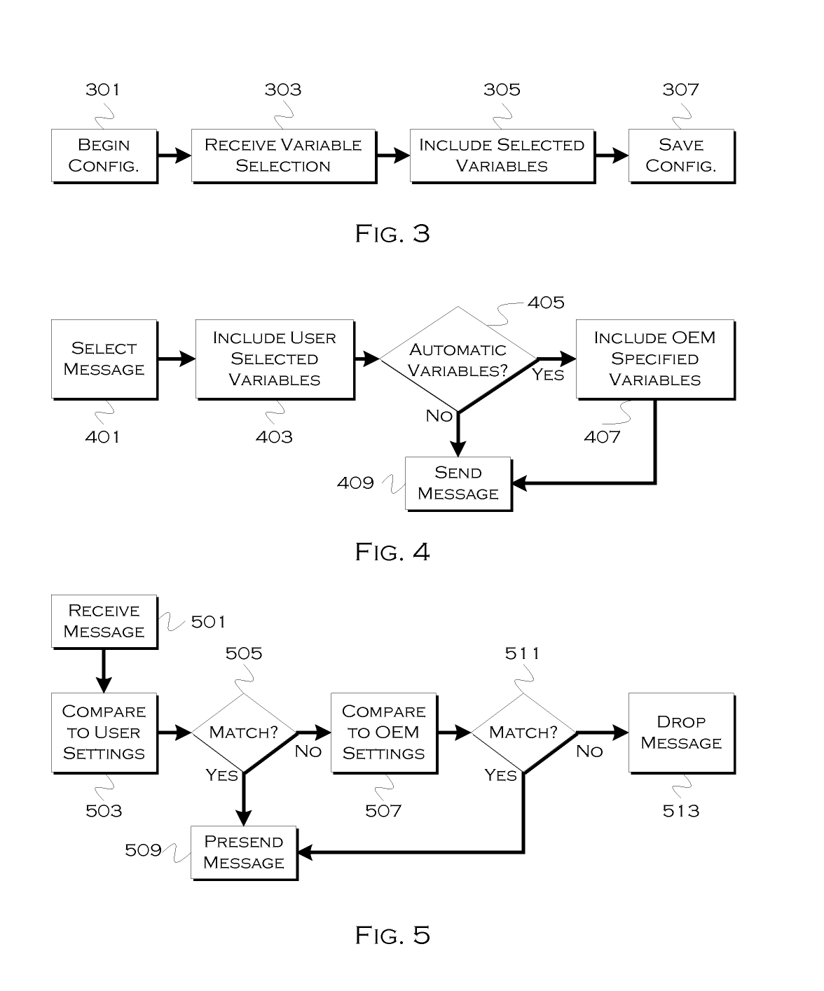

FIG. 4 shows an illustrative process for advertisement selection, generation and transmission. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the advertiser or requesting entity selects a predefined message for broadcast 401. This could be in response to an observed condition, for example, or in response to a request received from another local vehicle. Also, in some examples, the message could be automatically selected based on the occurrence of a trigger condition associated with the message (e.g., the vehicle receives a notification that it is passing by heavy traffic, an accident, etc.). When the message is selected, any of the user selected indicia variables are included 403. This could include a slight change in variables based on time of day (e.g., “lunch” around lunch time, “dinner” around dinner time, etc.) or a slight change in variables based on the nature of a trigger or request (e.g., “towing” for an accident or “gas delivery” for a stalled vehicle). If the size of a message is of concern, it may be useful to dynamically select variables to limit message size based on a triggering request, a receiving/transmitting vehicle state, an environmental state, etc.

Also, in this example, the process determines if there are any automatic variables that need to be included 405. These could include, for example, OEM approval indicia (if only approved advertisers can use a given OEM system), regulatory approval indicia, etc. If these are needed, the process will also include these indicia 407. The message as assembled can then be transmitted 409 via DSRC.

FIG. 5 shows another illustrative process for advertisement handling. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process determines how to handle a received message. As previously noted, all messages could be received and presented, received and sorted, or, as in this example, received and either discarded or presented based on indicia included in the message. These are simply some examples of how to handle a potentially high flow of messages if wide adaptation of these channels and processes occurs and other handling techniques may also be appropriate. In this example, the process receives a message 501, which, in this case, also contains some form of state or indicia to compare to a vehicle state or desired indicia. The included indicator is compared to any vehicle or user set states or indicia 503 and if there is a match 505, the process will present (or store) the message to one or more occupants 509. If there is no match with a present state, the process may also check the message for any OEM or other indicia that might give reason not to discard the message (if, for example, emergency messages were also broadcast in this manner) 507. If there is no match to any fixed standard for non-discardation of the message, the process may drop the message in this example 513 (or, for example, archive the message for some period of time) so as not to bother the user with a seemingly irrelevant message. In other examples, all messages may simply be passed to the user as previously noted.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive an indication of a trigger state indicating that a message should be broadcast over dedicated short-range communication (DSRC) from a broadcasting vehicle;
select a message, in response to the trigger state, for broadcast; and
broadcast the selected message while the trigger state persists.

2. The system of claim 1, wherein the trigger state includes a proximate traffic condition within a predefined proximity.

3. The system of claim 2, wherein the trigger state includes a traffic condition combined with a time-of-day.

4. The system of claim 1, wherein the trigger state includes any one of weather, time, and date corresponding to a preset condition.

5. The system of claim 1, wherein the processor is configured to automatically select the message based on a correspondence between the trigger state and a trigger state associated with the message.

6. The system of claim 1, wherein the processor is configured to receive vehicle occupant selection of the message to select the message.

7. The system of claim 1, wherein the processor is configured to include filtration indicia with the message defining a condition to which the message relates.

8. The system of claim 1, wherein the message indicates a product or service associated with the broadcasting vehicle.

9. The system of claim 1, wherein the message indicates a product or service desired by an occupant of the broadcasting vehicle.

10. A system comprising:
a processor configured to:
receive a dedicated short-range communication (DSRC) message from a local vehicle;
evaluate relevance of the message to a vehicle occupant; and
present the message to the vehicle occupant upon a determination that the message is relevant.

11. The system of claim 10, wherein the processor is configured to evaluate the relevance of the message based on indicia included with the message corresponding to a vehicle state or occupant preference.

12. The system of claim 11, wherein the processor is configured to automatically set the vehicle state or occupant preference based on occurrence of a predefined situation.

13. The system of claim 12, wherein the predefined situation includes an accident.

14. The system of claim 12, wherein the predefined situation includes a traffic condition affecting a vehicle containing the vehicle occupant.

15. The system of claim 11, wherein the processor is configured to receive occupant-input defining the vehicle state or occupant preference.

16. The system of claim 11, wherein the processor is configured to sort the message into a category for storage based on indicia, defining a message content relevance, included with the message.

17. The system of claim 10, wherein the processor is configured to broadcast a request, over DSRC, for messages having certain predefined indicia associated therewith, and to receive the DSRC message in response to the request.

18. The system of claim 17, wherein the processor is configured to automatically broadcast the request based on a determination that a situation corresponding to the predefined indicia has occurred.

19. The system of claim 17, wherein the processor is configured to broadcast the request based on an occupant input selecting the predefined indicia.

20. A system comprising:
a processor configured to:
establish communication with a local vehicle over a dedicated short-range communication (DSRC) channel based on receipt of a message from the local vehicle over the DSRC channel and a user-initiated communication request;
communicate with the local vehicle over the DSRC channel to facilitate a business transaction; and
establish a long-range persistent communication with the local vehicle upon a determination that the local vehicle is reaching the range limits of the DSRC channel and that further communication is desired.
